(19) United States
(12) Patent Application Publication
(10) Pub. No.: US 2018/0329756 A1
(43) Pub. Date: Nov. 15, 2018

(54) DISTRIBUTED PROCESSING SYSTEM, DISTRIBUTED PROCESSING METHOD, AND STORAGE MEDIUM

(71) Applicant: NEC Corporation, Tokyo (JP)

(72) Inventors: Masaki KAN, Tokyo (JP); Jun SUZUKI, Tokyo (JP); Yuki HAYASHI, Tokyo (JP)

(73) Assignee: NEC Corporation, Tokyo (JP)

(21) Appl. No.: 15/772,197

(22) PCT Filed: Nov. 10, 2016
(86) PCT No.: PCT/JP2016/083300

§ 371 Date: Apr. 30, 2018

(30) Foreign Application Priority Data
Nov. 13, 2015 (JP) 2015-223073

(51) Int. Cl. G06F 9/50; G06F 9/46; H04L 29/08

(52) U.S. Cl. CPC G06F 9/5072; G06F 9/5066; H04L 67/1097; G06F 9/465; H04L 67/2833; G06F 9/5027

(57) ABSTRACT

The present invention provides technology that improves the performance of a distributed processing system by preventing increases in data volume from causing deterioration of data access processing performance. A distributed processing system 1 comprises: a data holding device 11; and distributed processing devices 10 that have a distributed processing execution unit 101 and a data access processing unit 102. The data holding device 11 holds data that is used in distributed processing. The distributed processing execution unit 101 executes tasks that have been allocated to the device thereof in the distributed processing. The data access processing unit 102 issues access processing commands on a block-by-block basis for the blocks that constitute a storage area of the data holding device 11 by aggregating by block the access processing requests made of the data holding device 11 by the distributed processing execution unit 101.

### TECHNICAL FIELD

The present invention relates to a distributed processing technology.

### BACKGROUND ART

In recent years, performing data analysis processing such as machine learning on large-scale data is becoming generally accepted. Examples of implementation of a representative framework therefor include distributed processing middleware such as Hadoop. Hadoop is generally used to achieve a programing model called MapReduce proposed by Google as an open source.

MapReduce is a method for programming large-scale distributed processing by combining a Map function and a Reduce function. In MapReduce a program for repeatedly calculating the Map function and the Reduce function is executed. Such repeated calculation has an issue that performance becomes slow because intermediate data passed between the Map function and the Reduce function are read from and written to a storage device. In recent years, such repeated calculation frequently appears in processing of analyzing large-scale data such as machine learning. Thus, it is an important issue to solve this performance problem.

An example of a technology related to such an issue is described in NPL 1. In this related technology, intermediate data of repeated calculation are stored in a main memory of a computer cluster and processed on memory by reducing reading/writing on a storage device. Thus, enhanced speed is achieved.

Another example of a technology related to such an issue is described in PTL 1. In this related technology, when any information processing device that performs distributed processing accesses certain data, an information processing device that manages data having relevance to the data loads the data having the relevance into a cache.

### CITATION LIST

### Non Patent Literature

[NPL 1] “Apach Spark”, Internet <URL: http://spark.apache.org/>

### Patent Literature

[PTL 1] International Publication No. WO2014/155553

### SUMMARY OF INVENTION

### Technical Problem

However, the above-mentioned related technologies have the following issues.

In a general system using the Map function and the Reduce function, intermediate data are often accessed in a key value form. Thus, in such a general system, the intermediate data are stored in a data storage system in a key-value store (KVS) form. However, such a system accesses the data storage system in the KVS form with respect to each key and does not consider storage locations of a reading destination and a writing destination in the access processing. As a result, in such a general system, an increase in data volume increases the amount of data processing and the number of times for reading in reading processing, the number of times for writing in writing processing, and the like. Thus, performance in data access processing deteriorates.

In the related technology described in NPL 1, there is a problem that degradation in performance is caused when the main memory cannot hold all pieces of intermediate data. The reason is that a capacity of the main memory is limited in a general computer cluster. For example, a dynamic random access memory (DRAM) as the main memory has a capacity of about one-digit terabytes at most. In recent years, intermediate data of repeated calculation are increasing due to an increase in data volume. Thus, a large quantity of main memories need to be prepared in order to solve, under the technology described in NPL 1, the problem of degradation in performance due to reading/writing of increasing intermediate data. Consequently, multiple main memories and computers need to be prepared, and a cost considerably increases.

In the related technology described in PTL 1, although data used in distributed processing are prefetched and thus a rate of cache hits is improved, no mention is made of efficiency enhancement of processing of accessing to a device holding the prefetched data. Therefore, the related technology does not handle degradation in performance of the data access processing due to an increase in data to be used.

The present invention has been made in view of the above-mentioned issues. In other words, an object of the present invention is to provide a technology for preventing deterioration of performance of data access processing due to an increase in data volume and improving performance in a distributed processing system.

### Solution to Problem

To achieve the above-mentioned object, a distributed processing system of the present invention includes: a data holding device configured to hold data used in distributed processing; and one or more distributed processing devices each including distributed processing execution means for executing a task allocated to an own device in the distributed processing, and data access processing means for aggregating requests for processing of accessing to the data holding device by the distributed processing execution means, for each block which is a storage region of the data holding device, and thereby issuing an access processing instruction for each of the block.

A distributed processing device of the present invention includes: distributed processing execution means for executing a task allocated to an own device in distributed processing; and data access processing means for aggregating requests for processing of accessing to a data holding device by the distributed processing execution means, the data holding device being configured to hold data used in the distributed processing, for each block which is a storage region of the data holding device, and thereby issuing an access processing instruction for each of the block.

A method of the present invention is performed by each of one or more distributed processing devices that execute distributed processing, and the method includes: when executing a task allocated to an own device, aggregating requests for access processing to a data holding device configured to hold data used in distributed processing, for each block which is a storage region of the data holding device; and issuing an access processing instruction for each of the block.

A storage program of the present invention stores a program that causes a computer device to perform: a distributed processing execution step for executing a task allocated to an own device in distributed processing; and a data access processing step aggregating requests for access processing to a data holding device configured to hold data used in distributed processing, for each block which is a storage region of the data holding device, and thereby issuing an access processing instruction for each of the block.

### Advantageous Effects of Invention

The present invention is capable of providing a technology for preventing deterioration of performance of data access processing due to an increase in data volume and improving performance in a distributed processing system.

### BRIEF DESCRIPTION OF DRAWINGS

FIG. 1 is a block diagram illustrating a configuration of a distributed processing system as a first example embodiment of the present invention.

FIG. 2 is a diagram illustrating an example of a hardware configuration of the distributed processing system as the first example embodiment of the present invention.

FIG. 3 is a diagram illustrating another example of the hardware configuration of the distributed processing system as the first example embodiment of the present invention.

FIG. 4 is a diagram illustrating still another example of the hardware configuration of the distributed processing system as the first example embodiment of the present invention.

FIG. 5 is a flowchart for describing operations of the distributed processing system as the first example embodiment of the present invention.

FIG. 6 is a block diagram illustrating a configuration of a distributed processing system as a second example embodiment of the present invention.

FIG. 7 is a diagram for describing an example of information held by a list information holding unit in the second example embodiment of the present invention.

FIG. 8 is a block diagram illustrating a configuration of a data access processing unit in the second example embodiment of the present invention.

FIG. 9 is a flowchart for describing an outline of operations of the distributed processing system as the second example embodiment of the present invention.

FIG. 10 is a flowchart for describing a temporary holding operation of a writing request of the distributed processing system as the second example embodiment of the present invention.

FIG. 11 is a flowchart for describing writing processing of the distributed processing system as the second example embodiment of the present invention.

FIG. 12 is a flowchart for describing a temporary holding operation of a reading request of the distributed processing system as the second example embodiment of the present invention.

FIG. 13 is a flowchart for describing reading processing of the distributed processing system as the second example embodiment of the present invention.

FIG. 14 is a flowchart for describing an operation for adjusting a capacity of the distributed processing system as the second example embodiment of the present invention.

### DESCRIPTION OF EMBODIMENTS

Hereinafter, example embodiments of the present invention is described in detail with reference to drawings.

### First Example Embodiment

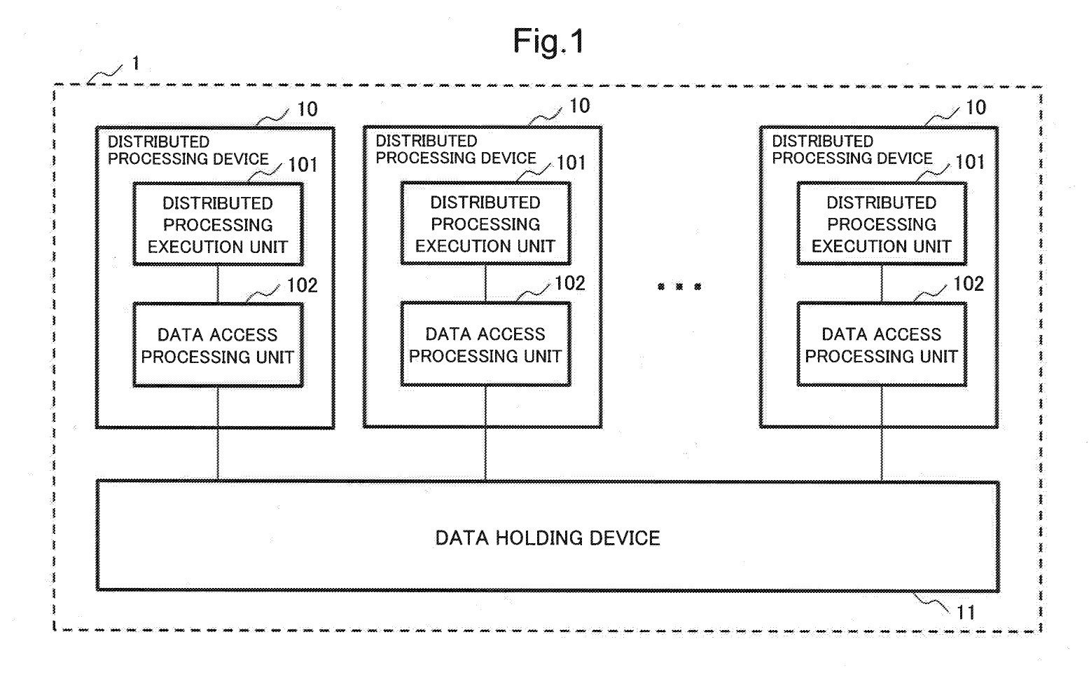

A functional block configuration of a distributed processing system 1 described as a first example embodiment of the present invention is illustrated in FIG. 1. In FIG. 1, the distributed processing system 1 includes one or more distributed processing devices 10 and a data holding device 11. Further, the distributed processing device 10 includes a distributed processing execution unit 101 and a data access processing unit 102. Although three distributed processing devices 10 are illustrated in FIG. 1, the number of distributed processing devices 10 included in the distributed processing system 1 of the present example embodiment is not limited to three.

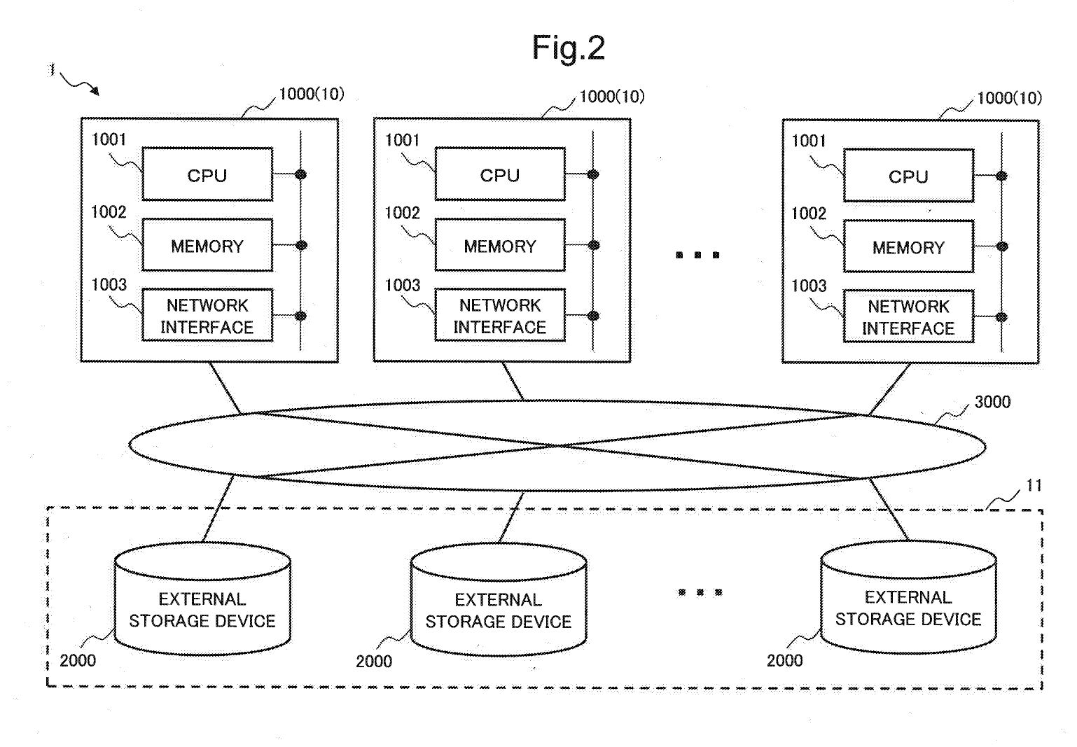

As illustrated in FIG. 2, a hardware configuration according to a resource disaggregated architecture is capable of being applied to the distributed processing system 1. The resource disaggregated architecture is an architecture on which a resource such as a storage is coupled to a Central Processing Unit (CPU) through an interconnect network and a server is constructed. By disaggregating resources such as a CPU, a storage, a power source, and a network that are components included in a computer, the resource disaggregated architecture enables replacement, addition, fallback, and the like thereof as necessary. In such an architecture, each CPU combines components via an interconnect network inside a rack and thereby achieve a server.

In FIG. 2, the distributed processing system 1 includes one or more computers 1000 and one or more external storage devices 2000. Further, a group of the computers 1000 and a group of the external storage devices 2000 are communicably connected with each other via an interconnect network 3000. Although three computers 1000 and three external storage devices 2000 are illustrated in FIG. 2, the number of computers 1000 and the number of external storage devices 2000 in the present example embodiment are not limited.

Each of the computers 1000 includes a CPU 1001, a memory 1002, and a network interface 1003. The memory 1002 is achieved by a random access memory (RAM), a read only memory (ROM), or the like. The memory 1002 may include an auxiliary storage device such as a hard disk drive (HDD), a solid state drive (SSD), and a non-volatile memory. The network interface 1003 is an interface connected to the interconnect network 3000. In this case, one or more distributed processing devices 10 are achieved by the computers 1000 respectively. Further, each functional block of the distributed processing device 10 is achieved by the network interface 1003 and the CPU 1001 that reads and executes a computer program stored in the memory 1002.

Each of the external storage devices 2000 is a device that stores data. The external storage device 2000 has a function of receiving from the outside an instruction of processing of accessing to stored data, and processing the access instruction of processing of accessing. The external storage device 2000 includes an interface connected to the interconnect network 3000. A storage region of the external storage device 2000 may be achieved by a flash memory, a DRAM, a magnetoresistive random access memory (MRAM), an HDD, an SSD, and the like. In this case, the data holding device 11 is achieved by one or more external storage devices 2000.

The interconnect network 3000 connects the group of the computers 1000 with the group of the external storage devices 2000. The interconnect network 3000 may be achieved by an optical fiber cable, a switch, and the like. Alternatively, the interconnect network 3000 may be achieved by a cable of Ethernet (registered trademark) or Peripheral Component Interconnect-Express (PCI-e), and the like.

Alternatively, the interconnect network 3000 may be achieved by ExpEther (registered trademark). ExpEther is a technology for achieving a PCI-e network using Ethernet. In this case, an interface having a function of ExpEther may be adopted as the network interface 1003 of the computer 1000. Further, a device having the function of ExpEther may be adopted as the external storage device 2000.

Examples of such a device include a flash memory supporting PCI-e, and a redundant arrays of inexpensive disks (RAID) card and a group of HDDs or SDDs via the RAID card. In addition, other examples of such a device include a card having a general-purpose computing on graphics processing units (GPGPU) function and including a memory device. Still, other examples of such a device include a computing board based on Many Integrated Core (MIC) architecture such as Intel Xeon Phi.

The configuration above can expand the interconnect network 3000 of PCI-e over Ethernet, and an architecture similar to the resource disaggregated architecture is achieved.

In this way, the distributed processing system 1 in the present example embodiment allows data used in distributed processing to be stored in the high-speed data holding device 11 connected with a group of the distributed processing devices 10 via the interconnect network 3000. In this case, each of the external storage devices 2000 included in the data holding device 11 may be achieved by a storage device, such as NAND Flash, that is faster than a HDD and has an excellent cost-capacity ratio while being slower than a DRAM.

As another example, the interconnect network 3000 may be achieved by Fibre Channel or Fibre Channel over Ethernet (FCoE). In this case, the computer 1000 may include a host bus adapter or an Ethernet card as the network interface 1003. Further, the external storage device 2000 may be a storage device including an interface connected to Fibre Channel or FCoE network. In such an architecture, a network connecting between the computers 1000 may be prepared in addition to the interconnect network 3000. For example, Ethernet by Transmission Control Protocol (TCP)/Internet Protocol (IP) may connect the computers 1000 together, and Fibre Channel may connect the computers 1000 with the external storage devices 2000.

The above-mentioned hardware configuration described by using FIG. 2 allows the computer 1000 to access the group of the external storage devices 2000 with a low delay. In addition, the above-mentioned hardware configuration allows one or more computers 1000 to share the group of the external storage devices 2000.

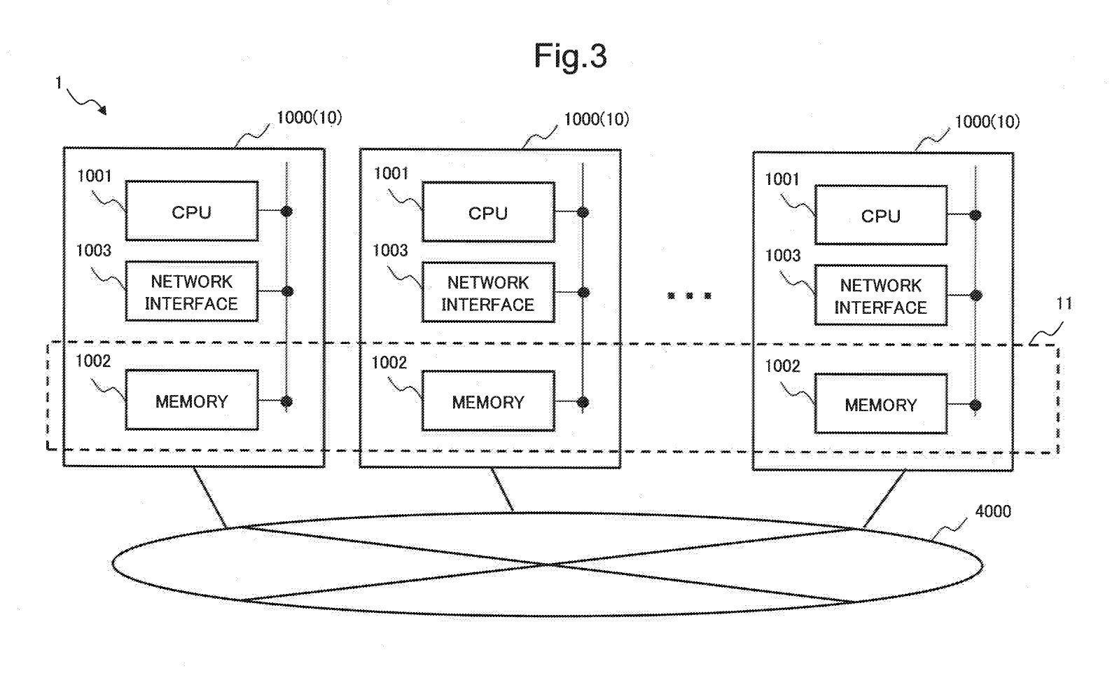

Another configuration may also be used as the hardware configuration of the distributed processing system 1. Another example of the hardware configuration is illustrated in FIG. 3. In FIG. 3, the distributed processing system 1 is achieved by one or more computers 1000. The computers 1000 are communicably connected with each other by an appropriate network 4000. In this case, each of the distributed processing devices 10 is achieved by the computer 1000. Further, the data holding device 11 is achieved by a group of the memories 1002 provided in a group of the computers 1000.

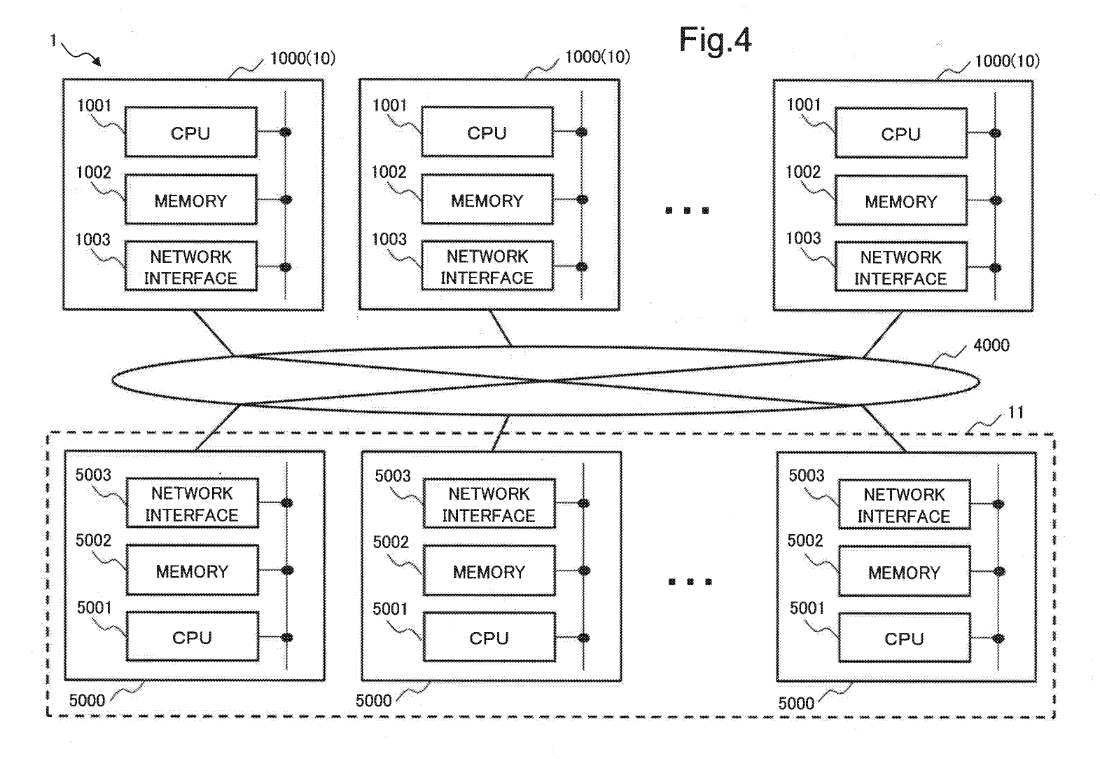

Still another example of the hardware configuration of the distributed processing system 1 is illustrated in FIG. 4. In FIG. 4, the distributed processing system 1 includes one or more computers 1000 and one or more computers 5000. A group of the computers 1000 and a group of the computers 5000 are communicably connected with each other by an appropriate network 4000. In this case, each of the distributed processing devices 10 is achieved by the computer 1000. Further, the data holding device 11 is achieved by the group of the computers 5000.

The hardware configuration of the distributed processing system 1 and each of the functional blocks are not limited to the above-mentioned configurations described by using FIGS. 2 to 4.

Next, details of each of the functional blocks are described.

The data holding device 11 holds data used in distributed processing. Specifically, data held by the data holding device 11 may be data shared among one or more distributed processing devices 10 executing distributed processing.

The distributed processing execution unit 101 in each of the distributed processing devices 10 executes a task allocated to its own device in distributed processing. For example, the distributed processing execution unit 101 executes a task allocated by a scheduler in any distributed processing middleware.

The data access processing unit 102 aggregates requests by the distributed processing execution unit 101 for processing of accessing to the data holding device 11, for each block of the data holding device 11. Specifically, a task executed by the distributed processing execution unit 101 generates a request for processing of reading data held by the data holding device 11. Further, a task executed by the distributed processing execution unit 101 generates a request for processing of writing generated data to the data holding device 11. Note that a block of the data holding device 11 refers to a region included in a storage region capable of storing data used in distributed processing. For example, the block may be one of regions generated by dividing the storage region into regions of a predetermined size. The data access processing unit 102 issues an aggregated instruction of access processing with respect to each block.

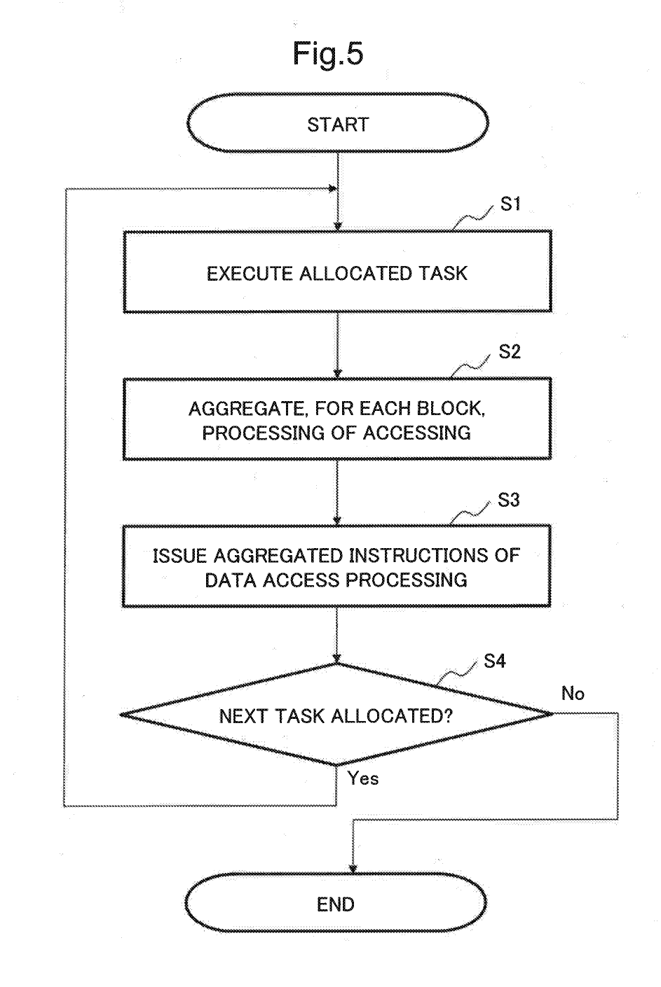

Operations of each of the distributed processing devices 10 in the distributed processing system 1 configured as described above is hereinafter described with reference to FIG. 5.

First, the distributed processing execution unit 101 executes a task allocated to its own device in distributed processing (step S1).

Next, the data access processing unit 102 aggregates, for each block, requests for processing of accessing to the data holding device 11, generated in the step S1 (step S2).

For example, the data access processing unit 102 temporarily holds the requests for the access processing generated in the step S1. Further, the data access processing unit 102 may aggregate the requests for the access processing for each block by specifying, at a predetermined opportunity, blocks associated with data that are object of the held requests for the access processing.

Next, the data access processing unit 102 issues, for each block, an aggregated instruction of access processing (step S3).

For example, the data access processing unit 102 may issue aggregated instructions of access processing for each block at the above-mentioned predetermined opportunity.

When the distributed processing device 10 has a next task allocated to its own device (Yes in the step S4), the distributed processing device 10 then repeats the operations from the step S1. When the distributed processing device 10 does not have a next task allocated to its own device (No in the step S4), the processing ends.

Next, an effect of the first example embodiment of the present invention is hereinafter described.

The distributed processing system as the first example embodiment of the present invention prevents deterioration of performance of data access processing due to an increase in data volume and improves the performance.

The reason is as follows. In the present example embodiment, the distributed processing execution unit in each of the distributed processing devices executes a task allocated to its own device. That generates processing of accessing to the data holding device that holds data used in the task or data generated in the task. The reason is that the data access processing unit then aggregates requests for the processing of accessing to the data holding device with respect to each of blocks which are access destinations in a storage region of the data holding device, and issues, for each block, an aggregated instruction of access processing.

In this way, the present example embodiment aggregates and issues the processing of accessing to the data holding device with respect to each block of the access destination. Thus, even when data volume increases, the number of times for the access processing can be significantly reduced in comparison with a case where the access processing is not aggregated. In other words, the present example embodiment reduces an access load on the data holding device. As a result, the present example embodiment significantly improves performance of data access processing.

### Second Example Embodiment

Next, a second example embodiment of the present invention is described in detail with reference to drawings. Note that in each of the drawings referred in description of the present example embodiment, the same elements and steps similarly working as those in the first example embodiment of the present invention have the same reference signs, and detailed description thereof is omitted in the present example embodiment.

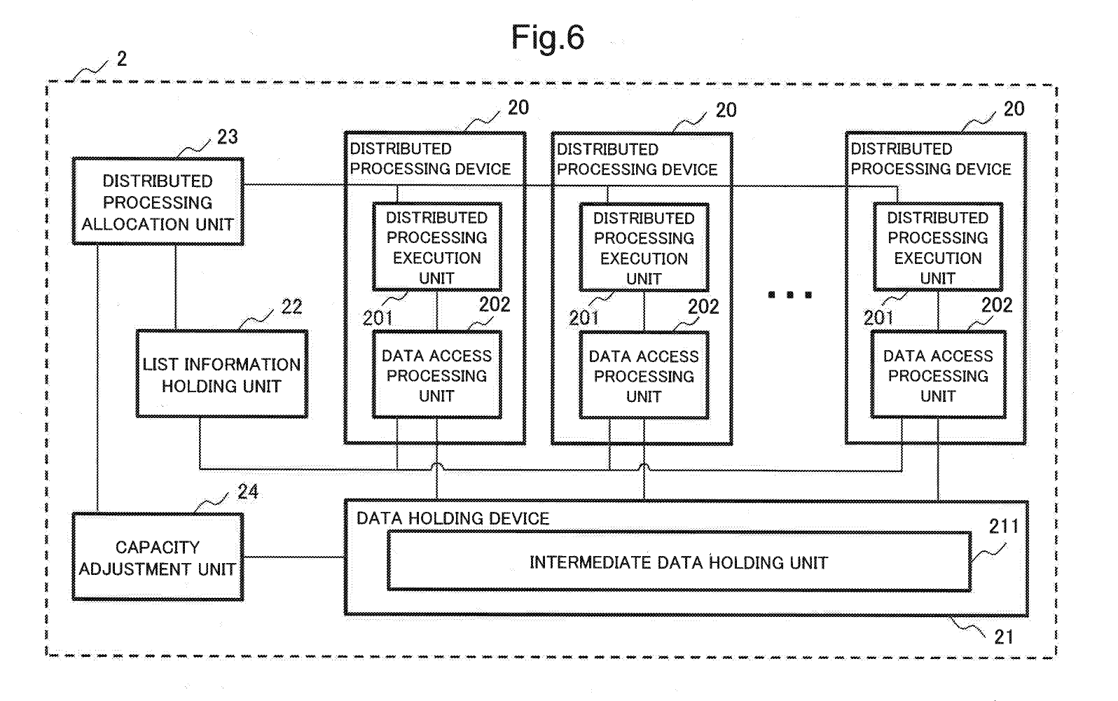

First, a configuration of a distributed processing system 2 as a second example embodiment of the present invention is illustrated in FIG. 6. In FIG. 6, the distributed processing system 2 includes a distributed processing device 20, a data holding device 21, a list information holding unit 22, a distributed processing allocation unit 23, and a capacity adjustment unit 24. The distributed processing device 20 includes a distributed processing execution unit 201 and a data access processing unit 202. The data holding device 21 includes an intermediate data holding unit 211.

The distributed processing system 2 may be achieved by the similar hardware components as those in the first example embodiment of the present invention described with reference to FIG. 2. In this case, the list information holding unit 22 is achieved by the memory 1002 of the computer 1000. Alternatively, the list information holding unit 22 may be achieved by a storage region of the external storage device 2000. Each of the distributed processing allocation unit 23 and the capacity adjustment unit 24 is implemented on any one or more computers 1000, and is achieved by the network interface 1003 and the CPU 1001 that reads and executes a computer program stored in the memory 1002 in the computer 1000. In addition, the distributed processing system 2 may also adopt any of other examples of the hardware configuration in the first example embodiment of the present invention described with reference to FIGS. 3 and 4. Note that the hardware configuration of the distributed processing system 2 is not limited to the above-mentioned configurations.

The data holding device 21 stores intermediate data for repeated computation in distributed processing in the intermediate data holding unit 211. The intermediate data are data generated and used by tasks allocated to one or more distributed processing devices 20. The intermediate data holding unit 211 may store one or more pieces of intermediate data in a key value form in a block.

Note that the data holding device 21 may hold other pieces of data needed for distributed processing in addition to the intermediate data.

The list information holding unit 22 holds information specifying intermediate data held by the intermediate data holding unit 211 in a form that the information is association with information indicating a block holding the intermediate data. A key is adopted as the information specifying the intermediate data herein. Further, a block ID identifying a block is adopted as the information indicating the block. Hereinafter, the information in which the key of the intermediate data is associated with the block ID is also referred to as list information.

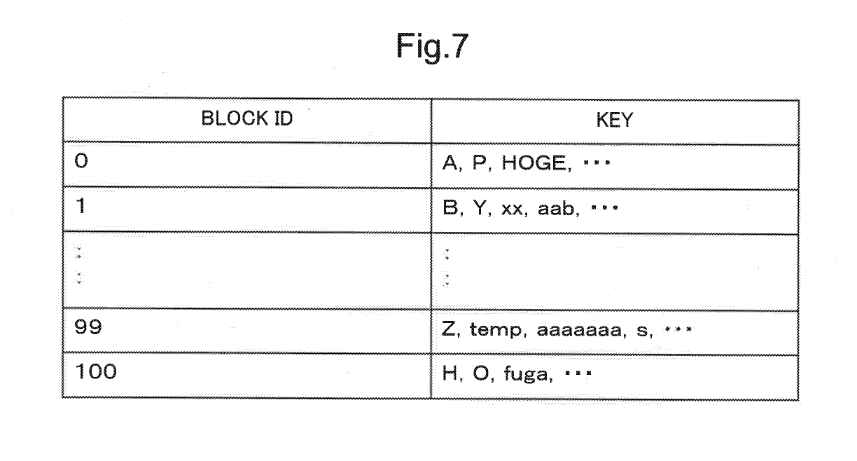

For instance, an example of list information held by the list information holding unit 22 is illustrated in FIG. 7. In FIG. 7, each row indicates a block ID in the intermediate data holding unit 211 and a key of intermediate data held by the block.

The distributed processing allocation unit 23 allocates tasks to be executed in a distributed manner to the distributed processing devices 20 in distributed processing. For example, the distributed processing allocation unit 23 may allocate, as tasks, any processing of the Map/Reduce function or the like in distributed processing middleware to the distributed processing devices 20. Further, for example, the distributed processing allocation unit 23 may allocate a task to an appropriate distributed processing device 20 on the basis of a state of each of the distributed processing devices 20 (for example, a state of data arrangement in a storage) or the like.

As for processing including access to intermediate data already stored in the intermediate data holding unit 211, the distributed processing allocation unit 23 allocates tasks as follows. The distributed processing allocation unit 23 in this case allocates tasks, which result from distribution of processing of accessing to the intermediate data holding unit 211 performed with respect to each block, to the distributed processing devices 20 on the basis of information held by the list information holding unit 22.

The distributed processing allocation unit 23 requests the capacity adjustment unit 24 described below to perform processing of adjusting a capacity of the intermediate data holding unit 211.

The capacity adjustment unit 24 adjusts a capacity of the intermediate data holding unit 211 in the data holding device 21. The reason that the capacity of the intermediate data holding unit 211 is adjusted is as follows. Improvement in access efficiency by aggregating data access instructions for each block ID varies depending on the capacity of the intermediate data holding unit 211. The access efficiency does not improve in a case where a plurality of pieces of intermediate data are not stored in the same block. However, when multiple pieces of intermediate data are already stored in the same block, the block can lacks sufficient room for holding another piece of intermediate data. In such a case, the data access processing unit 202 searches for another available block. Examples of a search method include a method for storing intermediate data in another block by using a method for adding an appropriate value to a key or a hash value thereof and rehashing (referred to as a double hashing method in general). When the rehashing occurs frequently, access to multiple storage regions are needed in order to search for a key, thereby resulting in deterioration of performance. In other words, as the intermediate data holding unit 211 has a smaller capacity and is filled with more pieces of intermediate data (i.e., as it has a higher filling rate), efficiency of aggregating reading processing at using intermediate data become higher, but more time is needed in order to search for a key. On the contrary, as the intermediate data holding unit 211 has a larger capacity and has a lower filling rate of intermediate data, time for searching for a key does not become longer, but the efficiency of aggregating reading processing does not become higher. Therefore, it is possible to improve the efficiency of aggregating reading processing without much increasing time for searching for a key by appropriately adjusting a capacity of the intermediate data holding unit 211.

The capacity adjustment unit 24 thus performs processing of changing a capacity of the intermediate data holding unit 211. The capacity adjustment unit 24 may determine and adjust a capacity of the intermediate data holding unit 211 on the basis of a total volume of intermediate data assumed to be held. The capacity adjustment unit 24 may use a value input via an input device (not illustrated) as an assumed total volume of intermediate data. In this case, the capacity adjustment unit 24 may adjust a capacity before the distributed processing system 2 starts a series of tasks. Alternatively, the capacity adjustment unit 24 may predict a total volume of intermediate data on the basis of a capacity of the intermediate data generated while the distributed processing system 2 executes a series of tasks, and determine and adjust a capacity of the intermediate data holding unit 211 on the basis of the predicted total volume.

An appropriate size of the intermediate data holding unit 211 with respect to the total volume of the intermediate data is determined according to a tendency of an access pattern. For example, when it is prioritized that intermediate data of required keys are acquired by access to at most three blocks, a volume of the intermediate data holding unit 211 may be determined to be about twice as large as a total volume of the intermediate data. Further, for example, when it is prioritized that efficiency of aggregating processing of reading intermediate data is maximized, a capacity of the intermediate data holding unit 211 may be determined to be substantially the same capacity as a total volume of the intermediate data.

The distributed processing execution unit 201 executes a task allocated to its own device by the distributed processing allocation unit 23. For example, as described above, the allocated task may be processing of the Map/Reduce function or the like.

The data access processing unit 202 is configured similarly to the data access processing unit 102 in the first example embodiment of the present invention, and is further configured as follows. When the access processing included in a task executed by the distributed processing execution unit 201 is writing processing, the data access processing unit 202 associates a key specifying data of a write object with a block ID of a writing destination, and registers the key and the block ID in the list information holding unit 22. When the access processing included in a task executed by the distributed processing execution unit 201 is reading processing, the data access processing unit 202 may refer to the list information holding unit 22, obtain a block ID of an access destination, and aggregate reading requests with respect to each block ID.

Data required for a task can be roughly divided into two kinds. A data processing program requested by a user is executed by sequentially processing a plurality of tasks. Hereinafter, the data processing program requested by a user is also referred to as a job. The first kind of the data required for a task is original data required for one or more tasks processed at first in the job. The second kind is intermediate data that are a result of processing a task and are passed to the next and subsequent tasks. Note that it is assumed that the intermediate data also include final data output by the data processing program.

The data access processing unit 202 may read the original data from the outside of the distributed processing system 2. Alternatively, when the original data are stored in the data holding device 21, the data access processing unit 202 may read the original data from the data holding device 21. Alternatively, when the original data are stored in the memories 1002 in the group of the computers 1000 included in the group of the distributed processing devices 20, the data access processing unit 202 may read the original data from the group of the memories 1002 in the group of the computers 1000.

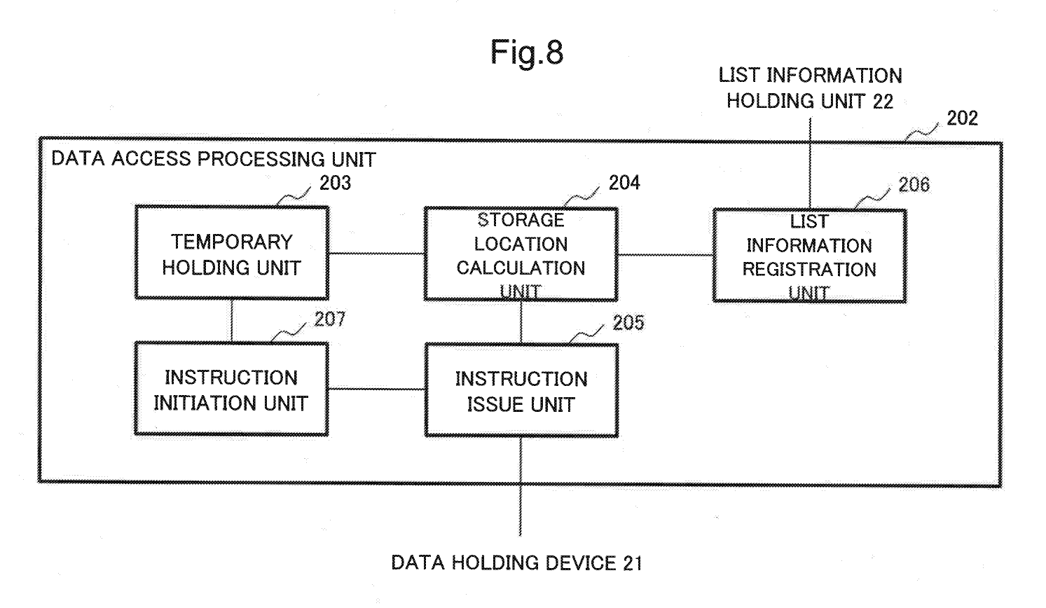

An example of a more detailed functional block configuration of the data access processing unit 202 is illustrated in FIG. 8. In FIG. 8, the data access processing unit 202 includes a temporary holding unit 203, a storage location calculation unit 204, an instruction issue unit 205, a list information registration unit 206, and an instruction initiation unit 207.

The temporary holding unit 203 is a region in which requests from the distributed processing execution unit 201 for reading/writing intermediate data is temporarily buffered.

In response to the request for reading/writing buffered by the temporary holding unit 203, the storage location calculation unit 204 calculates information specifying a block as a destination of reading/writing. For example, the storage location calculation unit 204 may calculate a block ID in the data holding device 21 on the basis of a key of intermediate data that is a read/write object and calculate an address of the block.

Specifically, the storage location calculation unit 204 obtains a block ID associated with a key of intermediate data. The storage location calculation unit 204 is capable of calculating an address of the block on the basis of the block ID. For example, the storage location calculation unit 204 may obtain the block ID from the key on the basis of information indicating a relationship between the key and the block ID. When the request is a reading instruction, the storage location calculation unit 204 may obtain a block ID associated with a key of intermediate data that is an object by referring to the list information holding unit 22. For example, the storage location calculation unit 204 may also obtain a block ID by applying a hash function to a key.

For instance, details under the case where a block ID is obtained by using a hash function to calculate an address is as follows. It is assumed herein that sequential numbers starting with zero are associated as block IDs in order from the first of blocks. In this case, the storage location calculation unit 204 calculates a hash value of a key with a hash function, and calculates a remainder obtained by dividing the calculated hash value by a total number of blocks. The storage location calculation unit 204 then determines the remainder as a block ID of the block storing the intermediate data. For example, when a remainder obtained as mentioned above for a key of a certain piece of intermediate data is two, the storage location calculation unit 204 calculates that a block associated with “2” as the block ID, more specifically a third block from the first, is the access destination of the piece of intermediate data. Then, the storage location calculation unit 204 may calculate an address of the block on the basis of an address of a top of a region in the intermediate data holding unit 211 and a block size.

When the data holding device 21 is achieved by the plurality of external storage devices 2000, the storage location calculation unit 204 may distribute access destinations, first determining which intermediate data holding unit 211 on the external storage device 2000 stores the intermediate data. Subsequently, as mentioned above, an address may be calculated by using the above-mentioned remainder on the basis of a total number of blocks in the intermediate data holding unit 211 on the external storage device 2000. For example, a technique called consistent hashing may be applied to the distributed processing.

The storage location calculation unit 204 calculates a physical address or a logical address as an address of the block specified as an access destination. When the data holding device 21 is achieved by the plurality of external storage devices 2000, the storage location calculation unit 204 further calculates information specifying an external storage device 2000 in addition to a physical address or a logical address as an address of the block specified as an access destination. Examples of the information specifying the external storage device 2000 include an IP address and a media access control access (MAC) address.

The instruction issue unit 205 aggregates and issues data access instructions for each block ID calculated by the storage location calculation unit 204. Note that when intermediate data stored in a block are updated, an exclusive control is required for the data holding device 21. In such a case, it is assumed that the data holding device 21 has a function of the exclusive control.

The list information registration unit 206 associates, when processing of writing the intermediate data is performed, a key of written intermediate data with information indicating a block (a block ID herein) where the intermediate data is written, and registers the key and the information into the list information holding unit 22.

The instruction initiation unit 207 processes, at a predetermined opportunity, a group of requests buffered by the temporary holding unit 203. Specifically, the instruction initiation unit 207 executes an instruction generated by aggregation of collectively processable requests from a list of requests held by the temporary holding unit 203. In other words, the instruction initiation unit 207 aggregates requests for reading of a group of intermediate data stored in the same block into one reading instruction, and issues the reading instruction. Further, the instruction initiation unit 207 aggregates writing (updating) requests for the same block into a one writing instruction, and issues the writing instruction.

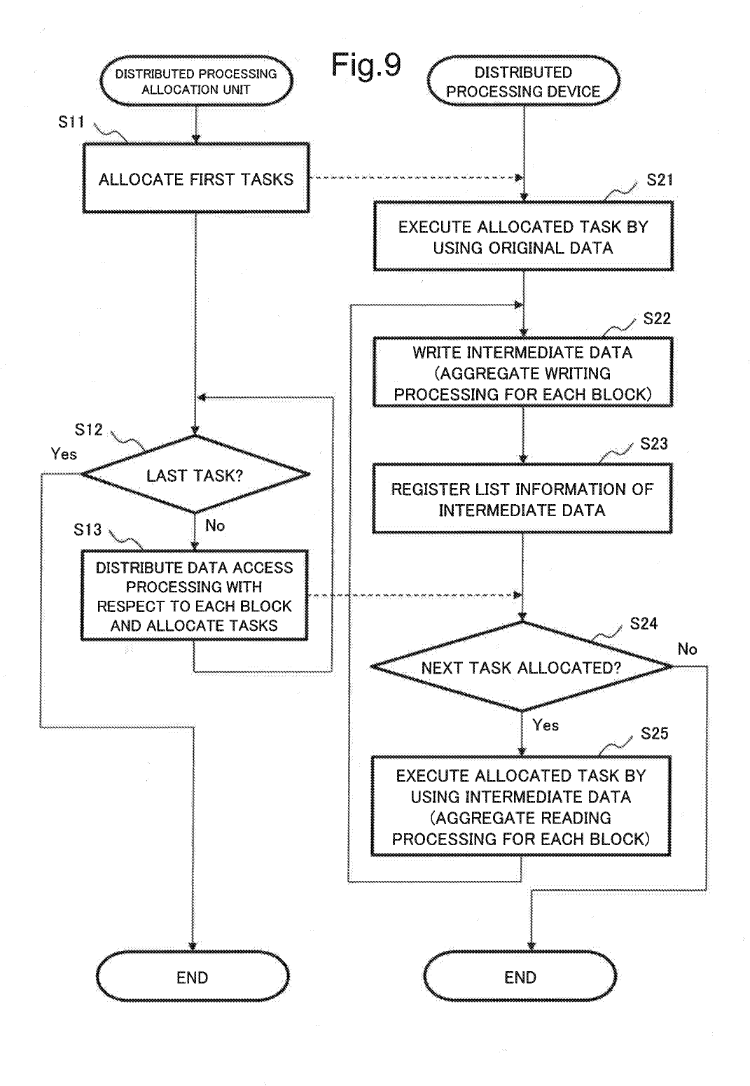

Operations of the distributed processing system 2 configured as described above is hereinafter described with reference to drawings. First, an outline of operations of distributed processing performed by the distributed processing system 2 is illustrated in FIG. 9. In FIG. 9, the left of the diagrams illustrates operations of the distributed processing allocation unit 23 while the right of the diagrams illustrates operations of each of the distributed processing devices 20. Operations performed when the distributed processing system 2 executes a job in which a plurality of tasks are processed is described herein.

First, the distributed processing allocation unit 23 allocates a first tasks in the job to the distributed processing devices 20 (step S11).

Next, the distributed processing execution unit 201 in each of the distributed processing devices 20 executes an allocated first task by using original data (step S21). As mentioned above, the distributed processing execution unit 201 may obtain the original data from the outside or a memory in each of the devices included in the distributed processing system 2. The distributed processing system 2 may not obtain the original data in a case where original data is not required for executing the first task.

Next, the distributed processing execution unit 201 requests the data access processing unit 202 to perform processing of writing intermediate data generated by the execution of the task into the intermediate data holding unit 211. Then, the data access processing unit 202 writes designated intermediate data to the intermediate data holding unit 211 (step S22). Details of this step will be described later.

Next, the data access processing unit 202 registers list information that associates a key of the written intermediate data with a block ID in the list information holding unit 22 (step S23).

When the tasks allocated last time is not the last tasks in the job (No in the step S12), the distributed processing allocation unit 23 works as follows. Specifically, the distributed processing allocation unit 23 allocates next tasks, which are generated such that data access processing are distributed with respect to each block, to the distributed processing devices 20 on the basis of the list information registered in the list information holding unit 22 (step S13). Processing contents of the next tasks are processing using the intermediate data from the previous tasks. Details of this step will be described later.

Next, when a next task is allocated (Yes in step S24), the distributed processing execution unit 201 in each of the distributed processing devices 20 works as follows. Specifically, the distributed processing execution unit 201 executes the allocated task by using intermediate data (step S25). At this time, the distributed processing execution unit 201 reads intermediate data required for executing the task from the intermediate data holding unit 211 by using the data access processing unit 202. Details of the processing of reading the intermediate data in this step will be described later.

Next, the distributed processing execution unit 201 writes the intermediate data and registers the list information by repeating the processing from the step S22.

When the tasks allocated last time is the last tasks in the job (Yes in the step S12), the distributed processing allocation unit 23 ends the processing. The distributed processing execution unit 201 in each of the distributed processing devices 20 ends the processing when a next task is not allocated (No in the step S24).

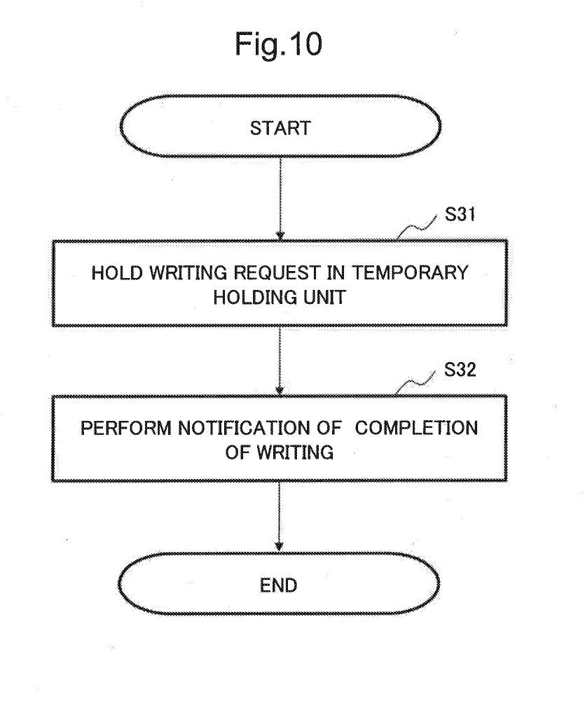

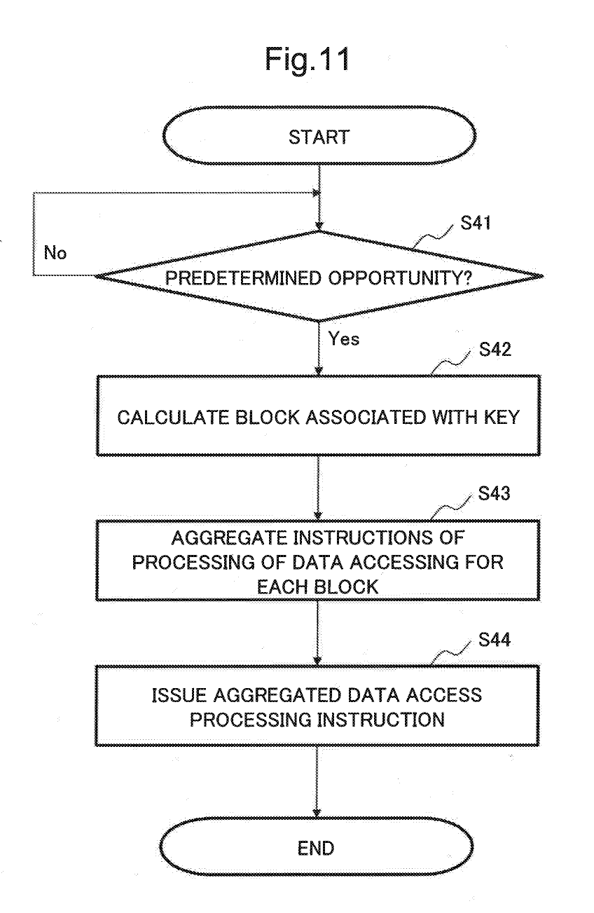

Next, details of the processing of writing intermediate data in the step S22 is described with reference to FIG. 10 and FIG. 11.

First, processing in response to a request from the distributed processing execution unit 201 for writing processing is illustrated in FIG. 10.

In FIG. 10, the data access processing unit 202 first holds a request from the distributed processing execution unit 201 for writing processing (i.e. writing request) in the temporary holding unit 203 (step S31).

Next, the data access processing unit 202 notifies the distributed processing execution unit 201 that the writing processing according to the writing request has been completed (step S32). The data access processing unit 202 may not necessarily execute this step. Alternatively, the data access processing unit 202 may execute this step after completion of actual writing (i.e. after step S44 described later).

Then the processing according to the request for the writing processing is finished.

Details of the writing processing at a predetermined opportunity are illustrated in FIG. 11.

In FIG. 11, the instruction initiation unit 207 first determines whether a predetermined opportunity has arrived (step S41). The predetermined opportunity may be timing at which a predetermined period of time lapsed. The predetermined opportunity may also be timing at which volume of requests held by the temporary holding unit 203 exceeds a threshold value. In such a case, the threshold value may be set not to exceed a capacity of a memory (main memory device) or the like included in the temporary holding unit 203.

When it is determined that the predetermined opportunity has arrived, the storage location calculation unit 204 calculates, for each request held by the temporary holding unit 203, information specifying blocks associated with keys of intermediate data that are an object (step S42).

As mentioned above, the storage location calculation unit 204 may obtain a block ID associated with a key and calculate an address in the intermediate data holding unit 211 by using the obtained block ID. As mentioned above, a hash table algorithm, a database storing a relationship between a key and a block ID, or the like may be used in the processing of obtaining a block ID associated with a key.

Next, the instruction issue unit 205 generates, for each calculated block, an aggregated access processing instruction which is generated by aggregating instructions of processing of accessing to intermediate data having any one of associated keys, (step S43). Writing instructions aggregated for respective blocks are generated herein.

Next, the instruction issue unit 205 issues the aggregated access processing instruction for each block (step S44). The writing instructions aggregated for respective block are issued herein.

Then the writing processing at the predetermined opportunity is finished. The detailed description of the processing of writing intermediate data in the step S22 is also finished.

Next, details of the processing of allocating tasks in the step S13 is described by using a specific example.

As the list information illustrated in FIG. 7, it is assumed herein that intermediate data are stored in each block of the intermediate data holding unit 211.

First, an example of processing of allocating tasks by general distributed processing is described for comparison with the present example embodiment. In the general distributed processing, keys are distributed on the basis of hashes, sort order or the like, and thereby tasks are allocated to a plurality of computers. For example, in the general distributed processing, tasks of processing data for respective remainder each of which is obtained by dividing a hash value of a key by the number of distributions are generated and allocated to the computers. Alternatively, in the general distributed processing, tasks are, after the list of the keys is sorted, divided so that each computer processes data associated with a certain number of keys, and then the tasks are allocated to the plurality of computers. For example, processing of intermediate data having a key which is a character string starting with any one of “A” to “Z” are allocated to a first computer. Further, processing of intermediate data having a key which is a character string starting with any one of “a” to “z” are allocated to a second computer.

In those case, with reference to FIG. 7, “A”, “P”, “HOGE”, “B”, “Y”, “Z”, “H”, and “O” are present as the keys starting with any one of “A” to “Z”. Pieces of the intermediate data each having the key starting with any one of “A” to “Z” are stored in at least four blocks, the block IDs of which are “0”, “1”, “99”, and “100”. Thus, the first computer to which the tasks of processing these pieces of intermediate data are allocated needs to access at least the four blocks. Further, with reference to FIG. 7, “xx”, “aab”, “temp”, “aaaaaaa”, “s”, and “fuga” are present as the key starting with any one of “a” to “z”. Pieces of the intermediate data each having the key starting with any one of “a” to “z” are stored in at least three blocks, the block IDs of which are “1”, “99”, and “100”. Thus, the second computer to which the tasks of processing these pieces of intermediate data are allocated needs to access at least the three blocks. Moreover, there are the blocks to which both of the computers needs to have access, and such a situation involves inefficiency.

In contrast, the information illustrated in FIG. 7 is registered in the list information holding unit 22 by the processing in the step S23 in the present example embodiment.

In this case, the distributed processing allocation unit 23 in the present example embodiment generates tasks into which tasks divided such that processing for intermediate data in the same block is included in the same generated task and allocates the generated tasks to the distributed processing devices 20. For example, tasks of processing intermediate data each having a key stored in a block having any one of “0” and “1” as the block ID are allocated to a first distributed processing device 20. Further, tasks of processing intermediate data each having a key stored in a block having any one of “99” and “100” as the block ID are allocated to a second distributed processing device 20.

In this case, the first and second distributed processing devices 20 may each access only two blocks, respectively, and those blocks do not overlap each other.

In this way, the operation of allocating tasks in the step S13 by the distributed processing allocation unit 23 in the present example embodiment reduces an amount of data read from the intermediate data holding unit 211 and the number of times for reading performed when each of the distributed processing devices 20 executes a task. As a result, a load on the data holding device 21 is reduced, and input/output time is shortened.

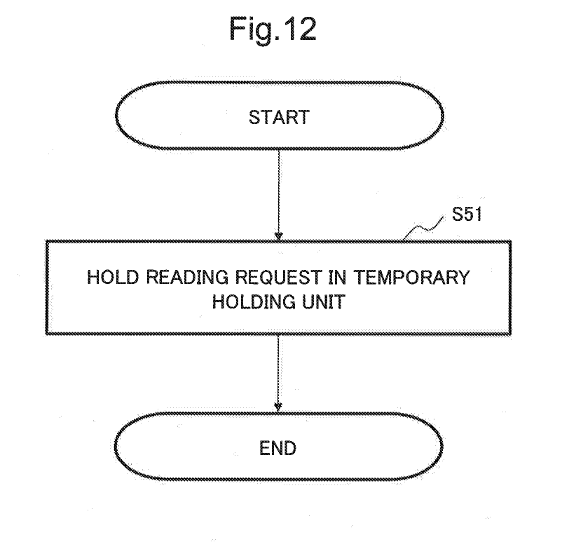

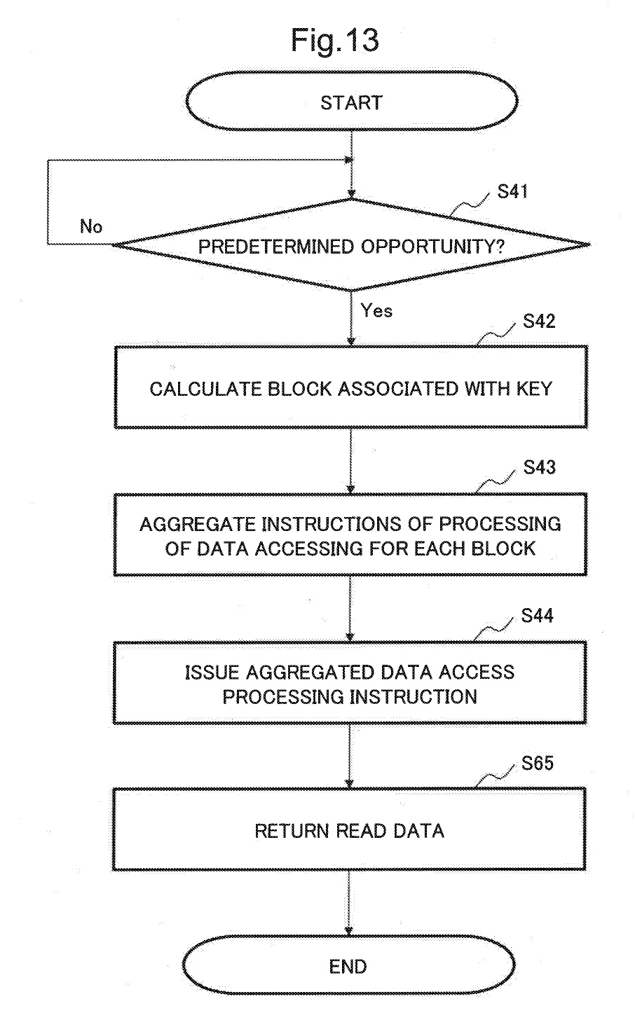

Next, details of the processing of reading intermediate data in the step S25 is described with reference to FIGS. 12 to 13.

First, processing in response to a request for reading processing from the distributed processing execution unit 201 is illustrated in FIG. 12.

In FIG. 12, the data access processing unit 202 holds a request from the distributed processing execution unit 201 for reading processing (i.e. reading request) in the temporary holding unit 203 (step S51).

Then the processing in response to the request for the reading processing is finished.

Next, details of the reading processing at a predetermined opportunity are illustrated in FIG. 13.

In FIG. 13, the data access processing unit 202 works from the steps S41 to S44 similarly to the case of the writing processing.

However, in the step S42, the storage location calculation unit 204 may obtain a block ID associated with a key by referring to the list information holding unit 22 instead of calculating information specifying a block on the basis of a key, and calculate an address of the block.

In the steps S43 to S44, the instruction issue unit 205 generates and issues a reading instruction as an aggregated access processing instruction.

Next, the data access processing unit 202 returns the read intermediate data to the distributed processing execution unit 201 (step S65).

Then the reading processing at the predetermined opportunity is finished. The detailed description of the processing of reading intermediate data in the step S25 is also finished.

Note that the data access processing unit 202 may skip the step S41 illustrated in FIG. 11 and FIG. 13. In this case, the data access processing unit 202 may start the processing from the step S42 at timing when receiving the request for the writing processing or the reading processing. In this case, the processing of temporarily holding a request illustrated in FIG. 10 or FIG. 12 and the aggregating processing in the step S43 are not needed. Particularly in the case of the reading processing, execution of a task by the distributed processing execution unit 201 can be suspended unless a reading instruction is not completed. Thus, the data access processing unit 202 may execute the processing from the step S42 every time the data access processing unit 202 receives an request for reading processing. In this case, however, an effect of improving performance by aggregating data access processing decreases. Thus, for example, order of execution may be previously adjusted such that, in the task including the processing of reading intermediate data, all reading processing precedes other processing. In this case, the effect of improving performance by aggregating data access processing can be expected even in the reading processing.

Then the description of the distributed processing operations of the distributed processing system 2 is finished.

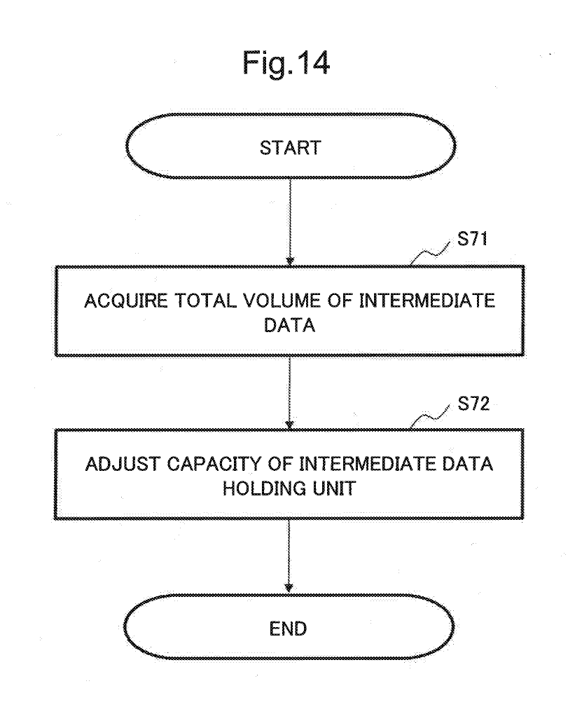

Next, an operation of adjusting a capacity of the intermediate data holding unit 211 by the distributed processing system 2 is illustrated in FIG. 14.

In FIG. 14, the capacity adjustment unit 24 acquires a total volume of intermediate data shared among the distributed processing devices 20 (step S71).

As mentioned above, the capacity adjustment unit 24 may acquire a total volume previously set via an input or the like. Alternatively, the capacity adjustment unit 24 may predict and obtain a total volume of intermediate data generated in a job of distributed processing on the basis of a volume of the intermediate data already generated during execution of the job.

Next, the capacity adjustment unit 24 adjusts a capacity of the intermediate data holding unit 211 in the data holding device 21 on the basis of the total volume of the intermediate data (step S72).

It is assumed that a method for calculating an appropriate size of the intermediate data holding unit 211 with respect to the total volume of the intermediate data is previously determined according to a tendency of an access pattern and the like. For example, as mentioned above, when it is prioritized that intermediate data of required keys are acquired by access to at most three blocks, the capacity adjustment unit 24 may adjust the volume of the intermediate data holding unit 211 to about twice as large as the total volume of the intermediate data. For example, when it is prioritized that efficiency of aggregating processing of reading the intermediate data is maximized, the capacity adjustment unit 24 may adjust the capacity of the intermediate data holding unit 211 to be substantially the same capacity as the total volume of the intermediate data.

The description of the operation of adjusting a capacity is finished.

Next, an effect of the second example embodiment of the present invention is described.

The distributed processing system as the second example embodiment of the present invention prevents deterioration of performance of data access processing due to an increase in intermediate data shared between tasks and improves the performance.

The reason is as follows. The reason is that the present example embodiment has the following configuration in addition to the same configuration as that of the first example embodiment of the present invention. The data holding device is capable of holding, for each block, one or more pieces of intermediate data shared between tasks in distributed processing in a key value form. Further, the list information holding unit is capable of holding a key of intermediate data held by the data holding device in a form that the key is associated with a block ID. The data access processing unit associates the key of the written intermediate data with the block ID and registers the key and the block ID in the list information holding unit when the access processing is writing processing. Then, the reason is that the distributed processing allocation unit allocates, on the basis of information held by the list information holding unit, tasks resulting from division performed such that the processing of accessing to the data holding device is distributed per block to the distributed processing devices.

In this way, in the present example embodiment, intermediate data that is an object of reading processing generated in a task allocated to the distributed processing devices are aggregated for each block. Therefore, the present example embodiment can reduce the number of blocks, of the data holding device, that need to be accessed when the distributed processing devices execute tasks, and can also improve data access performance.

A further reason is that the capacity adjustment unit adjusts a capacity of the intermediate data holding unit in the data holding device in the present example embodiment.

Thus, a filling rate of intermediate data in the intermediate data holding unit can be adjusted in the present example embodiment. As mentioned above, a higher filling rate increases efficiency of aggregating reading processing while the time for searching for a key increases. A lower filling rate reduces the time for searching for a key while the efficiency of aggregating reading processing is reduced. In the present example embodiment, a predetermined calculation method for a total volume of intermediate data is used according to an access pattern of data, and a capacity of the intermediate data holding unit is adjusted. As a result, the present example embodiment can improve the data access performance with consideration given to the time for searching for a key and the efficiency of aggregating reading processing.

The present example embodiment described above is described on the assumption that intermediate data are reused in a job. The present example embodiment is not limited to this and is also applicable to a case where intermediate data are shared between different jobs.

The above description of the present example embodiment includes the description of example in that the data holding device holds intermediate data and the data access processing unit aggregates processing of accessing to the intermediate data for each block. The present example embodiment is not limited to this. The data holding device may hold original data, and the data access processing unit may aggregate processing of accessing to the original data for each block.

The present example embodiment described above is described on the assumption that the distributed processing execution unit stores data in the key value form in the data holding device and that the data access processing unit registers a key of the data as information specifying the data in the list information holding unit. However, the form of the data, for writing and reading, stored in the data holding device by the distributed processing device is not limited to the key value form and may be any other form. In such a case, the data access processing unit may associate any pieces of information specifying data with information indicating a block that is a writing destination and register the pieces of information in the list information holding unit.

The present example embodiment described above is described on the assumption that the list information holding unit holds a block ID as information indicating a block associated with information specifying data. However, the information indicating the block is not limited to the block ID and may be any other information. In such a case, the data access processing unit may associate any pieces of information indicating a block that is a writing destination with information specifying written data and register the pieces of information in the list information holding unit.

The above description of the present example embodiment includes the description of the example in which the distributed processing allocation unit includes processing of accessing to two blocks in one task. However, this example does not limit the number of blocks that are an object of processing of accessing included in one task by the distributed processing allocation unit.

The above description of each of the above-mentioned example embodiments of the present invention includes the description that the data holding device stores one or more pieces of data for each block. A hash table, a Not Only SQL (NoSQL) system, a database system, a distributed cache system, and the like are applicable to the data holding device.

In each of the above-mentioned example embodiments of the present invention, the distributed processing device may be implemented as a member node of distributed processing middleware. However, the distributed processing device is not limited to this, and the distributed processing device may be a device configured to directly execute a distributed processing program without causing the distributed processing middleware to work.

While examples of the hardware configuration of the distributed processing system are illustrated by FIGS. 2 to 4 in each of the above-mentioned example embodiments of the present invention, the hardware configuration are not limited to them. The distributed processing system may be achieved by various hardware configurations adopted to a general distributed processing system.

In each of the above-mentioned example embodiments of the present invention, the description is mainly given to the example in which each of the functional blocks of the distributed processing system is achieved by the CPU executing the computer program stored in the storage device or the ROM. Each of the functional blocks is not limited to this, and a part or the whole of each of the functional blocks or a combination of the functional blocks may be achieved by dedicated hardware.

In each of the above-mentioned example embodiments of the present invention, operations of each of the units in the distributed processing system described with reference to the flowcharts may be stored in the storage device (i.e. storage medium) as the computer program of the present invention. The computer program may be read and executed by the CPU. In such a case, the present invention is realized by a code of the computer program or the storage medium.

The above-mentioned example embodiments may be appropriately combined and carried out.

The present invention has been described with above-mentioned example embodiments as typical examples. However, the invention is not limited to the above-mentioned example embodiments. Various aspects understood by those of ordinary skill in the art may be applied to the present invention within scope of the present invention.

The present application claims the benefits of priority based on Japanese Patent Application No. 2015-223073, filed on Nov. 13, 2015, the entire disclosure of which is incorporated herein by reference.

### REFERENCE SIGNS LIST

1, 2 distributed processing system
10, 20 distributed processing device
11, 21 data holding device
22 list information holding unit
23 distributed processing allocation unit
24 capacity adjustment unit
101, 201 distributed processing execution unit
102, 202 data access processing unit
203 temporary holding unit
204 storage location calculation unit
205 instruction issue unit
206 list information registration unit
207 instruction initiation unit
211 intermediate data holding unit
1000, 5000 computer
2000 external storage device
3000 interconnect network
4000 network
1001, 4001 CPU
1002, 4002 memory
1003, 4003 network interface

1. A distributed processing system comprising:
a data holding device configured to hold data used in distributed processing; and
one or more distributed processing devices each of which includes a processor configured to:
execute an allocated task in the distributed processing;
aggregate requests for processing of accessing to the data holding device, for each block included in a storage region of the data holding device, the requests being generated from the allocated task; and
issue an access processing instruction for each of the block, the access processing instruction being generated as a result of aggregating the requests.

2. The distributed processing system according to claim 1 further comprising:
list information holding storage configured to hold data information specifying data held by the data holding device, in a form that the data information is associated with block information indicating the block storing the data; and
a second processor configured to allocate tasks to each of the distributed processing devices, the tasks being generated by dividing tasks in such a way that the access processing to the data holding device in the distributed processing is distributed with respect to each block, based on information held by the list information holding storage, wherein
the processor in the distributed processing devices is further configured to associate, when the access processing is writing processing, the data information specifying data that is a write object with the block information indicating a block as a writing destination, and registers the data information and the block information in the list information holding storage.

3. The distributed processing system according to claim 1 further comprising a third processor configured to adjust a whole capacity of the storage region capable of storing the data in the data holding device.

4. (canceled)

5. A distributed processing method performed by a distributed processing device that executes distributed processing, the method comprising:
when executing a task allocated to the distributed processing device,
aggregating requests for processing of accessing to a data holding device configured to hold data used in distributed processing, for each block included in a storage region of the data holding device, the requests being generated from the allocated task; and
issuing an access processing instruction for each of the block, the access processing instruction being generated as a result of aggregating the requests.

6. A non-transitory computer-readable storage medium storing a program that causes a computer device to perform:
executing a task allocated to the computer device in distributed processing;
aggregating requests for processing of accessing to a data holding device configured to hold data used in distributed processing, for each block included in a storage region of the data holding device, the requests being generated from the allocated task; and
issuing an access processing instruction for each of the block, the access processing instruction being generated as a result of aggregating the requests.
